(19) United States
(12) Patent Application Publication
(10) Pub. No.: US 2026/0326012 A1
(43) Pub. Date: Oct. 22, 2026

(54) FILTER CLEANING DEVICE

(71) Applicant: KOWA Inc., Ama-shi Aichi (JP)

(72) Inventor: Kazuki NAKAGAWA, Ama-shi Aichi (JP)

(21) Appl. No.: 19/115,781

(22) PCT Filed: Jul. 5, 2023
(86) PCT No.: PCT/JP2023/024979

§ 371 Date: Mar. 27, 2025

(30) Foreign Application Priority Data
Dec. 2, 2022 (JP) 2022-193836

(51) Int. Cl. B01D 46/76; B01D 46/52; B01D 46/68; F24F 8/90

(52) U.S. Cl. CPC B01D 46/76; B01D 46/521; B01D 46/68; F24F 8/90

(57) ABSTRACT

[Problem] Provided with a filter cleaning device capable of reducing a manufacturing cost and capable of cleaning a filter frequently each time when a vehicle is used.

[Solution] A filter cleaning device 10 includes a filter body 1 including a filter 1a and a filter frame 1b; a dust removing body 2 configured to strike the filter body 1 or vibrate the filter body 1 for removing a dust attached to the filter body 1; and a movable mechanism 3 configured to support the dust removing body 2 and control a movement of the dust removing body 2, wherein the movable mechanism 3 is configured to relatively move the dust removing body 2 with respect to a filter 1a by an inertia force generated by an acceleration, a deceleration and a steering of a vehicle.

### TECHNICAL FIELD

The present invention relates to a filter cleaning device provided on a vehicle air conditioner of an automobile or the like.

### BACKGROUND ART

In a vehicle air conditioner, when an outside air is taken in and conditioned to feed the outside air inside the vehicle, the outside air is supplied inside the vehicle after the outside air is purified through a filter. Since dust included in the outside air is deposited in the filter to cause the clogging of the filter, a cleaning of the filter is required.

Similarly, when the inside air is circulated inside the vehicle, the filter is provided for purifying dust generated inside the vehicle. Thus, the cleaning of the dust deposited in the filter is required.

The invention of automating the cleaning of the filter is conventionally known (Patent Document 1).

In the vehicle air conditioner disclosed in Patent Document 1, when a glove box is opened for housing small articles, a wire pulls a brush box and a scraping member eliminates foreign materials on the air filter and discharges them from a discharge air duct. When the glove box is closed, the brush box and the scraping member are returned to the original positions by a tensile coil spring.

### PRIOR ART DOCUMENTS

### Patent Documents

[Patent Document 1] Japanese Unexamined Patent Application Publication No. 2007-216712

### SUMMARY OF THE INVENTION

### Problem to be Solved by the Invention

The above described vehicle air conditioner disclosed in Patent Document 1 does not require a motor for driving the scraping member and wiring for supplying electricity to the motor are not required. Thus, the manufacturing cost can be reduced. However, when the glove box is not opened or closed, the dust is still deposited in the filter. There is a problem to cause the clogging of the filter.

The present invention is made for solving the above described conventional problem and aims for providing a filter cleaning device capable of reducing the manufacturing cost without requiring the motor and the electric wiring and capable of cleaning the filter frequently each time when the vehicle is used.

### Means for Solving the Problem

In order to solve the above described problem, the invention of claim 1 is a filter cleaning device provided on a vehicle air conditioner, the filter cleaning device including: a filter body including a filter and a filter frame; a dust removing body configured to strike the filter body or vibrate the filter body for removing a dust attached to the filter body; and a movable mechanism configured to support the dust removing body and control a movement of the dust removing body, wherein the movable mechanism is configured to relatively move the dust removing body with respect to the filter by an inertia force generated by an acceleration, a deceleration and a steering of a vehicle.

In the invention of claim 1, the movable mechanism is configured to relatively move the dust removing body with respect to the filter by the inertia force generated by the acceleration, the deceleration and the steering of the vehicle. Thus, the motor and the electric wiring are not required and the manufacturing cost can be reduced. Since the inertia force generated by the acceleration, the deceleration and the steering of the vehicle is generated each time when the vehicle is used, the filter can be frequently cleaned. Since the dust removing body is configured to strike the filter body or vibrate the filter body for removing a dust attached to the filter body, fine dust contained in exhaust gas or the like and entered inside the filter can be removed efficiently.

The invention of claim 2 is the invention according to claim 1, wherein the movable mechanism includes a support base having a rod shape or a rail shape for supporting the dust removing body, one end or both ends of the support base is fixed near the filter, and the dust removing body is configured to move along a longitudinal direction of the support base by the inertia force generated by the acceleration, the deceleration and the steering of the vehicle. Consequently, the inertia force can be converted into the force along the longitudinal direction of the support base to use the inertia force. Since a predetermined position of the filter can be struck by the dust removing body, the dust can be removed efficiently.

The invention of claim 3 is the invention according to claim 1, wherein the movable mechanism includes: a support base having a rod shape or a rail shape for supporting the dust removing body; and a guide rail configured to slidingly contact with a sliding member formed on an end portion or a center portion of the support base for supporting the sliding member, the support base is configured to reciprocate along a longitudinal direction of the guide rail by the inertia force generated by the acceleration, the deceleration and the steering of the vehicle, the guide rail is provided near an end portion of the filter, and the dust removing body is fixed to the support base or configured to move along a longitudinal direction of the support base by the inertia force generated by the acceleration, the deceleration and the steering of the vehicle. Consequently, the inertia force can be converted into the force in the linear direction along the filter to use the force. Since a wide area of the filter can be struck by the dust removing body, the dust can be removed efficiently in the entire filter.

The invention of claim 4 is the invention according to claim 3, wherein the guide rail includes a buffer device near an end portion of the guide rail in the longitudinal direction, and the buffer device is configured to generate a repulsive force to the support base when the support base is approached to the buffer device or contacted with the buffer device for buffering a collision with the guide rail. Consequently, even when large inertia force is applied, the movable mechanism is prevented from being damaged.

The invention of claim 5 is the invention according to claim 3, wherein a first load per unit length of the support base in the longitudinal direction at a first portion supported by the guide rail near the sliding member is larger than a second load per unit length of the support base at a second portion other than the first portion near the sliding member. Consequently, the inertia force applied on the support base can be increased and the deformation of the support base is suppressed. Thus, the support base can be slid on the guide rail smoothly.

The invention of claim 6 is the invention according to claim 1, wherein the movable mechanism includes a support base having a rod shape or a rail shape for supporting the dust removing body, one end of the support base is rotatably fixed to a rotation axis near the filter and the other end of the support base is a free end which is reciprocally movable, and the dust removing body is fixed to the support base or configured to move along a longitudinal direction of the support base by the inertia force generated by the acceleration, the deceleration and the steering of the vehicle. Consequently, the movable mechanism can be simplified and the manufacturing cost can be reduced.

The invention of claim 7 is the invention according to claim 1, wherein the movable mechanism includes a support base having an approximately lid shape provided at a position facing the filter sandwiching the dust removing body, and the dust removing body is configured to freely move along the support base by the inertia force generated by the acceleration, the deceleration and the steering of the vehicle. Consequently, the movable mechanism can be simplified and the manufacturing cost can be reduced. Since the dust removing body is not restrained by the rail or the like, the dust removing body can be moved smoothly in the acting direction of the inertia force.

The invention of claim 8 is the invention according to claim 2 or 3, wherein the support base includes a buffer device near an end portion of the support base in the longitudinal direction, and the buffer device is configured to generate a repulsive force to the dust removing body when the dust removing body is approached to the buffer device or contacted with the buffer device for buffering a collision with the support base. Consequently, even when large inertia force is applied, the movable mechanism is prevented from being damaged.

The invention of claim 9 is the invention according to any one of claims 1 to 7, wherein the filter includes a plurality of pleats, and the dust removing body is configured to strike the plurality of pleats or vibrate the plurality of pleats for removing the dust attached to the filter. Consequently, the dust removing body is configured to strike or vibrate the filter including a plurality of pleats to remove the dust. Thus, the movable mechanism can be simplified and the manufacturing cost can be reduced.

The invention of claim 10 is the invention according to claim 9, wherein the dust removing body has an approximately spherical shape, and the dust removing body is configured to rotate on a surface of the filter to strike the plurality of pleats by the inertia force generated by the acceleration, the deceleration and the steering of the vehicle. Consequently, the movable mechanism can be further simplified and the manufacturing cost can be reduced. Since the excessive friction to the filter can be reduced while the dust removing body gives a shock to the filter, the durability is improved and the maintenance frequency can be reduced.

The invention of claim 11 is the invention according to claim 9, wherein the filter includes a reinforcing member in a part of the plurality of pleats for maintaining a shape of the filter, and the dust removing body is configured to strike the reinforcing member for vibrating the filter. Consequently, the durability of the filter including the plurality of pleats can be improved by the reinforcing member. Since the shape of the filter is maintained, the dust removing body can give a shock easily and the shock can be transferred to the entire filter easily. Thus, the dust can be removed more efficiently.

The invention of claim 12 is the invention according to any one of claims 1 to 7, wherein the longitudinal direction of the guide rail or the support base in the movable mechanism is inclined with respect to a horizontal direction. Consequently, the gravity acts on the dust removing body and the dust removing body can be moved to one end of the filter even when the inertia force does not act on the vehicle. Thus, the dust removing body is prevented from being stopped at an intermediate position of the filter and the ventilation into a room is prevented from being blocked.

The invention of claim 13 is the invention according to any one of claims 1 to 7, wherein a dust box is formed at a portion near the filter and at least at one of end portions in a direction orthogonal to a moving direction of the dust removing body. Consequently, the dust removed from the filter by the dust removing body can be accumulated in the dust box and the accumulated dust can be collectively discharged to the outside.

The invention of claim 14 is the invention according to any one of claims 1 to 7, wherein a movable range of the dust removing body moved by the movable mechanism includes a position where the dust removing body and the filter body are not contacted with each other. Consequently, the filter body is struck or the filter body is vibrated powerfully. Thus, the dust can be surely removed from the filter. In addition, the first action of the dust removing body becomes smooth and the dust removing body can be moved smoothly even by a small inertia force of the vehicle.

### Effect of the Invention

In the invention of claim 1, the motor and the electric wiring are not required, the manufacturing cost can be reduced, and the filter can be cleaned frequently. In the invention of claim 2, the inertia force can be converted into the force along the longitudinal direction of the support base to use the inertia force. In the invention of claim 3, the inertia force can be converted into the force in the linear direction along the filter to use the force.

In the invention of claims 4 and 8, even when large inertia force is applied, the movable mechanism is prevented from being damaged. In the invention of claim 5, the inertia force applied on the support base can be increased and the deformation of the support base is suppressed. Thus, the support base can be slid on the guide rail smoothly. In the invention of claims 6, 7, 9 and 10, the movable mechanism can be simplified and the manufacturing cost can be reduced.

In the invention of claim 11, the durability of the filter including the plurality of pleats can be improved by the reinforcing member. In the invention of claim 12, the dust removing body is prevented from being stopped at an intermediate position of the filter and the ventilation into a room is prevented from being blocked.

In the invention of claim 13, the dust removed from the filter by the dust removing body can be accumulated in the dust box and the accumulated dust can be collectively discharged to the outside.

In the invention of claim 14, the dust can be surely removed from the filter.

### BRIEF DESCRIPTION OF DRAWINGS

FIG. 1A is a cross-sectional view showing a state that a filter cleaning device is installed in a vehicle air conditioner concerning the present invention. FIG. 1B is a perspective view showing the first embodiment of the filter cleaning device concerning the present invention.

FIG. 2A is a side view showing a case where the inertia force is applied backward of the vehicle. FIG. 2B is a side view showing a case where the inertia force is applied frontward of the vehicle.

FIGS. 3A and 3B are perspective views showing the second embodiment of the filter cleaning device concerning the present invention.

FIG. 4 is a perspective view of the third embodiment of the filter cleaning device concerning the present invention.

FIG. 5A is a cross-sectional view showing the first embodiment of a buffer device. FIG. 5B is a cross-sectional view showing the second embodiment of the buffer device. FIG. 5C is a cross-sectional view showing the third embodiment of the buffer device.

FIG. 6 is a perspective view showing the fourth embodiment of the filter cleaning device concerning the present invention.

FIGS. 7A and 7B are perspective views showing the fifth embodiment of the filter cleaning device concerning the present invention. FIG. 7C is a perspective view of a support base constituting the filter cleaning device of the fifth embodiment.

FIGS. 8A and 8B are perspective views showing the sixth embodiment of the filter cleaning device concerning the present invention. FIG. 8C is a perspective view of a support base constituting the filter cleaning device of the sixth embodiment.

FIG. 9 is a perspective view showing the seventh embodiment of the filter cleaning device concerning the present invention.

### MODES FOR CARRYING OUT THE INVENTION

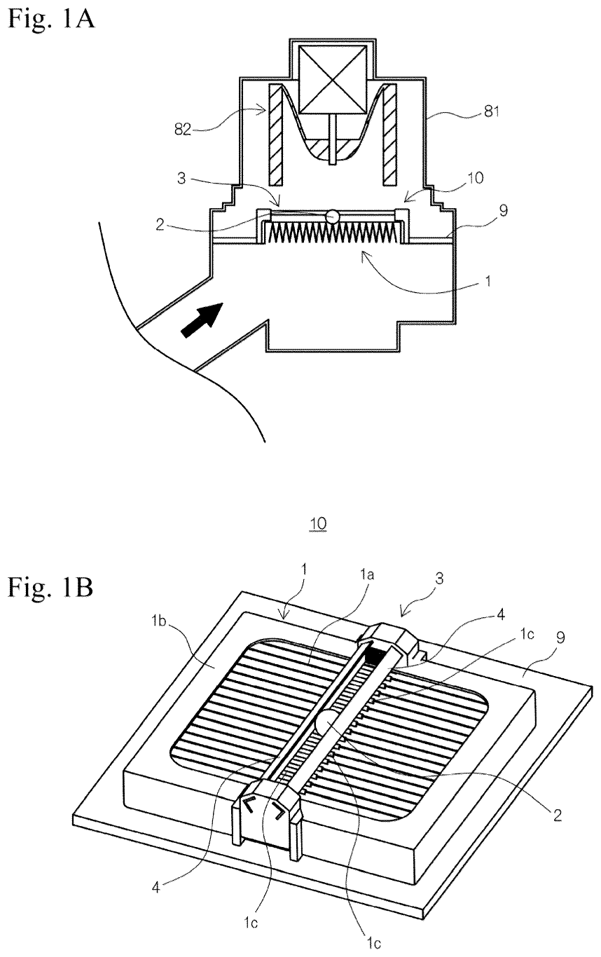

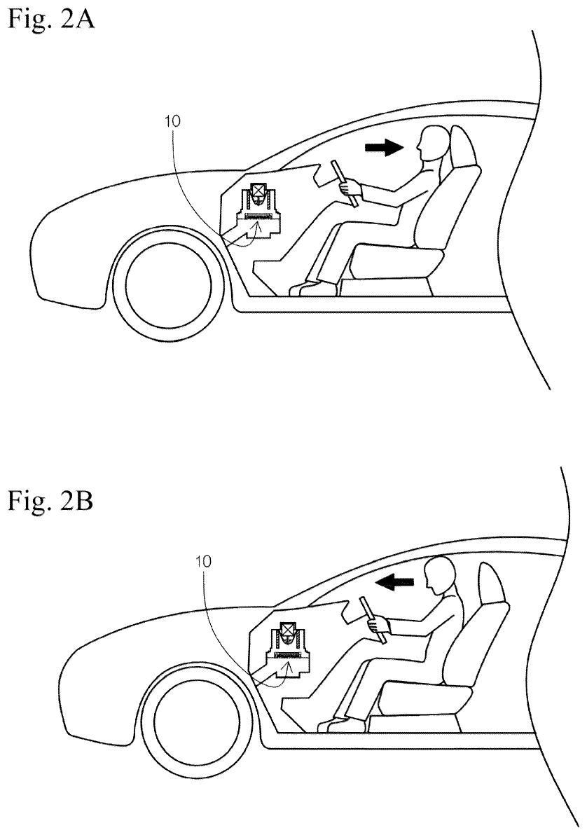

Hereafter, the embodiments of the present invention will be explained with reference to the drawings. Note that the present invention is not limited to the embodiments described below. FIG. 1A is a cross-sectional view showing a state that a filter cleaning device is installed in a vehicle air conditioner concerning the present invention. FIG. 1B is a perspective view showing the first embodiment of the filter cleaning device concerning the present invention. FIG. 2A is a side view showing a case where the inertia force is applied backward of the vehicle. FIG. 2B is a side view showing a case where the inertia force is applied frontward of the vehicle. The first embodiment of the filter cleaning device concerning the preset invention will be explained using the above described drawings.

A filter cleaning device 10 of the first embodiment is installed in a vehicle air conditioner. As shown in FIG. 1A, the filter cleaning device 10 is installed in an upstream side of a blower fan 82 installed inside a vehicle air conditioner body case 81, and the filter cleaning device 10 is installed in an air passage into which the outside air is introduced in the arrow direction via a base 9. The air passed through a filter body 1 is supplied to inside the vehicle.

The filter cleaning device 10 includes: a filter body 1 including a filter 1a and a filter frame 1b; a dust removing body 2 configured to strike the filter body 1 or vibrate the filter body 1 for removing a dust attached to the filter body 1; and a movable mechanism 3 configured to support the dust removing body 2 and control a movement of the dust removing body 2.

The movable mechanism 3 enables the dust removing body 2 to move relatively with respect to the filter 1a by an inertia force generated by an acceleration, a deceleration and a steering of the vehicle. Consequently, the motor and the electric wiring are not required and the electricity of the vehicle is not used. Thus, an environmentally friendly structure can be achieved without burdening the power consumption of the whole vehicle and the manufacturing cost can be reduced. Since the inertia force generated by the acceleration, the deceleration and the steering of the vehicle is generated each time when the vehicle is used, the filter 1a can be frequently cleaned. Since the dust removing body 2 is configured to strike the filter body 1 or vibrate the filter body 1 for removing the dust attached to the filter body 1, fine dust contained in exhaust gas or the like and entered inside the filter 1a can be removed efficiently. It is also possible for the dust removing body 2 to strike the filter frame 1b to give a shock to the filter frame 1b. Such a configuration is included in the present invention.

The movable mechanism 3 includes a support base 4 having a rod shape or a rail shape for supporting the dust removing body 2. One end or both ends of the support base 4 is fixed near the filter 1a, and the dust removing body 2 is configured to move along a longitudinal direction of the support base 4 by the inertia force generated by the acceleration, the deceleration and the steering of the vehicle. Consequently, the inertia force can be converted into the force in the linear direction along the filter to use the force. Since a predetermined position of the filter 1a can be struck by the dust removing body 2, the dust can be removed efficiently. When the support base has a rod shape, it is assumed that the cross-sectional shape of the support base is a polygonal shape or a circular shape. When the support base has a rail shape, a rail supporting the dust removing body from both sides or a rail supporting the dust removing body by only one side is assumed. The support base is included in the present invention as long as the support base has the function of supporting the dust removing body.

The filter 1a includes a plurality of pleats and the dust removing body is configured to strike the plurality of pleats or vibrate the plurality of pleats for removing the dust attached to the filter. Consequently, the dust removing body 2 is configured to strike or vibrate the filter 1a including a plurality of pleats to remove the dust. Thus, the movable mechanism 3 can be simplified and the manufacturing cost can be reduced. Although not illustrated, when the filter having a planar shape is adopted, the dust removing body is configured to strike the surface of the filter or give a shock to the surface of the filter in the vertical direction with respect to the surface of the filter to remove the dust attached to the filter. Such a configuration is included in the present invention. Even when the dust removing body strikes the filter frame to give a shock to the entire filter body without striking the filter directly, such a configuration is included in the present invention.

The filter 1a includes a reinforcing member 1c in a part of the plurality of pleats for maintaining the shape of the filter 1a. The dust removing body 2 is configured to strike the reinforcing member 1c for vibrating the filter 1a. Consequently, the durability of the filter 1a including the plurality of pleats can be improved by the reinforcing member 1c. Since the shape of the filter 1a is maintained, the dust removing body 2 can give a shock easily and the shock can be transferred to the entire filter 1a easily. Thus, the dust can be removed more efficiently. Note that the resin or the hot melt is assumed as the structure of the reinforcing member. The reinforcing member is included in the present invention as long as the reinforcing member has the function of reinforcing the filter.

The dust removing body 2 has an approximately spherical shape and the dust removing body 2 is configured to rotate on a surface of the filter 1a to strike the plurality of pleats by the inertia force generated by the acceleration, the deceleration and the steering of the vehicle. Consequently, the movable mechanism 3 can be further simplified and the manufacturing cost can be reduced. Since the excessive friction to the filter 1a can be reduced while the dust removing body 2 gives a shock to the filter 1a, the durability is improved and the maintenance frequency can be reduced.

The longitudinal direction of the support base 4 in the movable mechanism 3 is inclined with respect to a horizontal direction. Consequently, the gravity acts on the dust removing body 2 and the dust removing body 2 can be moved to one end of the filter 1a even when the inertia force does not act on the vehicle. Thus, the dust removing body 2 is prevented from being stopped at an intermediate position of the filter. Consequently, the ventilation into a room is prevented from being blocked.

Note that a movable range of the dust removing body 2 moved by the movable mechanism 3 preferably includes a position where the dust removing body 2 and the filter body 1 are not contacted with each other. Consequently, the filter body 1 is struck or the filter body is vibrated powerfully. Thus, the dust can be surely removed from the filter 1a. In addition, the first action of the dust removing body becomes smooth and the dust removing body can be moved smoothly even by a small inertia force of the vehicle.

Here, the inertia force is the force generated by the acceleration, the deceleration and the steering of the vehicle. When the vehicle is accelerated, as shown in FIG. 2A, the inertia force is applied from the front to the rear of the driver. Thus, the inertia force is also applied to the movable mechanism 3 of the filter cleaning device 10 from the front to the rear. Therefore, the dust removing body 2 located at the vehicular front side of the filter body 1 is moved to the vehicular rear side of the filter body 1. On the contrary, when the vehicle is decelerated, as shown in FIG. 2B, the inertia force is applied from the rear to the front of the driver. Thus, the inertia force is also applied to the movable mechanism 3 of the filter cleaning device 10 from the rear to the front. Therefore, the dust removing body 2 located at the vehicular rear side of the filter body 1 is moved to the vehicular front side of the filter body 1. Although not illustrated, the inertia force is generated also when the traveling direction of the vehicle is changed by the steering. Thus, the dust removing body 2 can be moved relatively with respect to the filter body 1. Even when the surface of the filter body 1 is raised along the vertical direction and arranged facing the front-rear direction or the left-right direction, the dust removing body can be relatively moved with respect to the filter body by the inertia force generated by the acceleration and the deceleration of the vehicle or the inertia force generated by the steering to change the traveling direction of the vehicle.

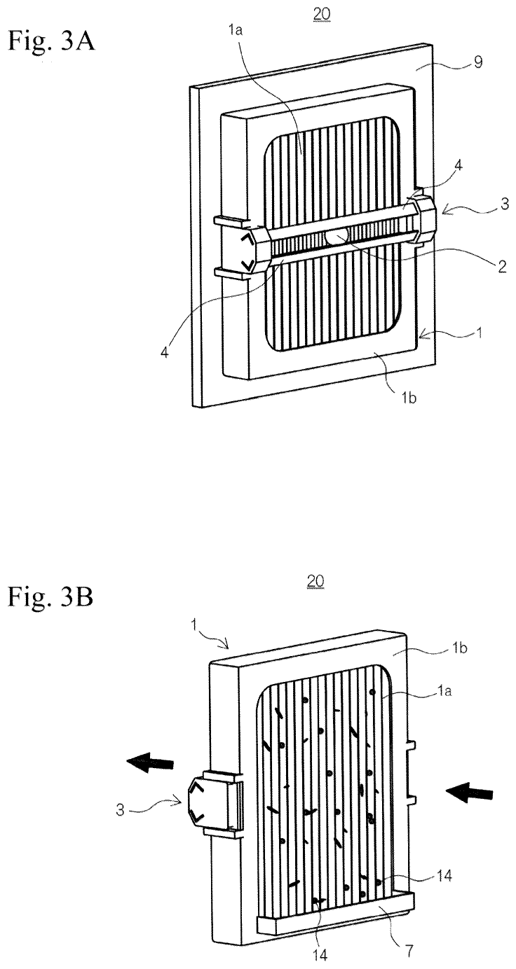

FIGS. 3A and 3B are perspective views showing the second embodiment of the filter cleaning device concerning the present invention. FIG. 3A illustrates the filter cleaning device from the downstream side of the filter. FIG. 3B illustrates the filter cleaning device from the upstream side of the filter. Note that FIG. 3B shows the state that the base 9 is detached. The second embodiment assumes the state where the surface of the filter body 1 is raised along the vertical direction. In a filter cleaning device 20 of the second embodiment, a dust box 7 is formed at a portion near the filter 1a and at one of end portions in a direction orthogonal to a moving direction of the dust removing body 2. Consequently, dust 14 removed from the filter 1a by the dust removing body 2 can be accumulated in the dust box 7 and the accumulated dust 14 can be collectively discharged to the outside. The explanation of the other configurations is omitted since the configurations are the same as the filter cleaning device 10 of the first embodiment.

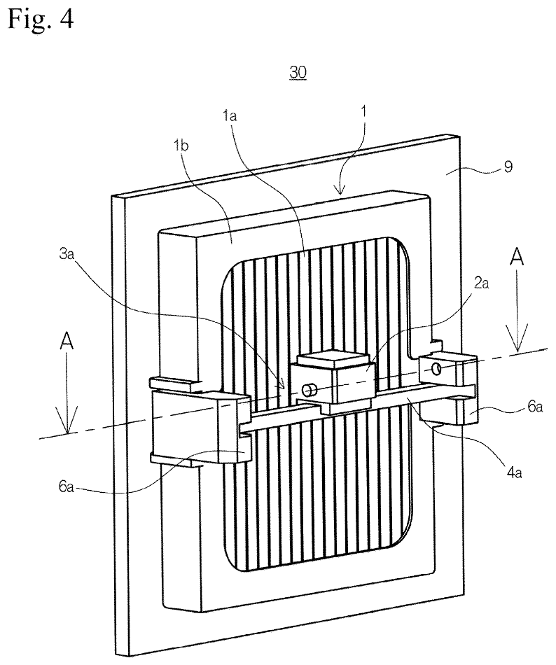

FIG. 4 is a perspective view of the third embodiment of the filter cleaning device concerning the present invention. In a filter cleaning device 30 of the third embodiment, a support base 4a includes a buffer device 6a near an end portion of the support base 4a in the longitudinal direction, and the buffer device 6a is configured to generate a repulsive force to the dust removing body 2a when the dust removing body 2a is approached to the buffer device 6a or contacted with the buffer device 6a for buffering a collision with the dust removing body 2a. Consequently, even when large inertia force is applied, the dust removing body 2a and the movable mechanism 3a are prevented from being damaged.

A notched portion 1c is formed near the end portion of the support base 4a between the support base 4a and the filter frame 1b. Thus, the dust removing body 2a and the filter body 1 are not contacted with each other. Consequently, when the dust removing body 2a is moved to the end portion of the support base 4a, the resistance applied to the dust removing body 2a is reduced. Thus, the first action of the dust removing body becomes smooth and the dust removing body 2a can be moved powerfully. Therefore, the dust removing body 2a can give a strong shock to the filter 1a.

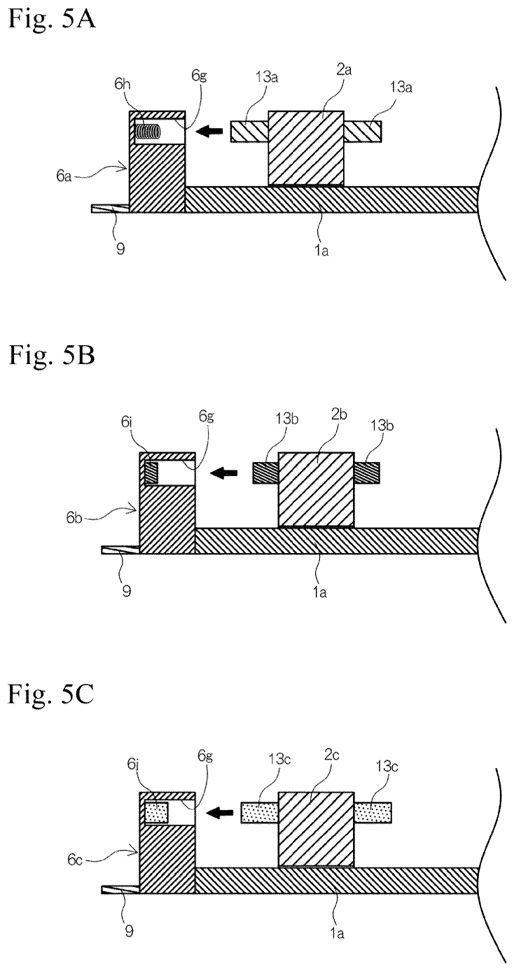

FIGS. 5A to 5C are cross-sectional views showing the first to third embodiments of the buffer device using A-A cross-section shown in FIG. 4. The buffer device 6a of the first embodiment shown in FIG. 5A is provided near both end portions of the support base 4 in the longitudinal direction. Insertion holes 6g, 6g are formed on a side portion of the buffer device 6a for inserting projected portions 13a, 13a formed on the dust removing body 2a into the insertion holes 6g, 6g. In addition, a spring 6h is provided on the insertion hole 6g as a biasing means. When the projected portion 13a of the dust removing body 2a presses the spring 6h, the projected portion 13a is bounced. Consequently, even when large inertia force is applied, the movable mechanism 3 is prevented from being damaged.

A buffer device 6b of the second embodiment shown in FIG. 5B is formed near both end portions of the support base 4 in the longitudinal direction. Insertion holes 6g, 6g are formed on a side portion of the buffer device 6b for inserting projected portions 13b, 13b formed on a dust removing body 2b and made of a magnet into the insertion holes 6g, 6g. In addition, a magnet 6i is provided on the insertion hole 6g. The projected portion 13b side of the magnet 6i has the same magnetic pole as the opposing surface of the projected portion 13b. When the projected portion 13b of the dust removing body 2b approaches the magnet 6i, the projected portion 13b is bounced. Consequently, even when large inertia force is applied, the movable mechanism 3 is prevented from being damaged.

A buffer device 6c of the third embodiment shown in FIG. 5C is provided near both end portions of the support base 4 in the longitudinal direction. The insertion holes 6g, 6g are formed on a side portion of the buffer device 6c for inserting projected portions 13c, 13c formed on a dust removing body 2c and made of a soft material into the insertion holes 6g, 6g. In addition, a cushion member 6j made of a soft material is provided on the insertion hole 6g. When the projected portion 13c of the dust removing body 2c abuts on the cushion member 6j, the projected portion 13c and the cushion member 6j are deformed for absorbing the impact force. Consequently, even when large inertia force is applied, the movable mechanism 3 is prevented from being damaged.

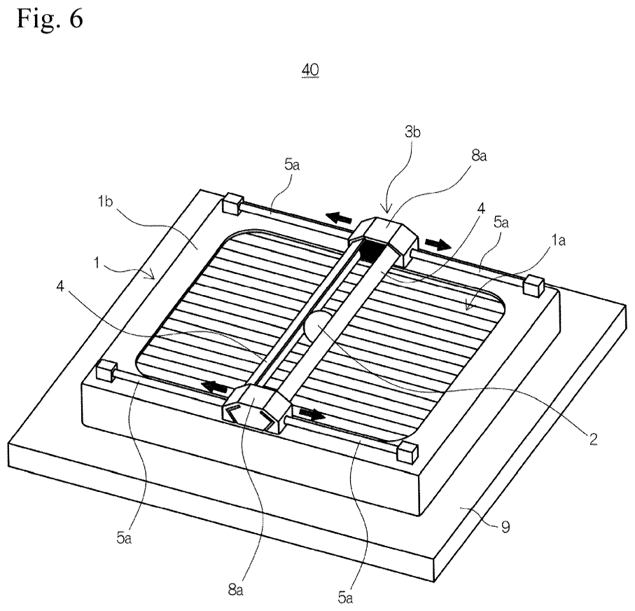

FIG. 6 is a perspective view showing the fourth embodiment of the filter cleaning device concerning the present invention. In a filter cleaning device 40 of the fourth embodiment, a movable mechanism 3b includes: the support base 4 having a rail shape for supporting the dust removing body 2 and guide rails 5a, 5a configured to slidingly contact with sliding members 8a, 8a for supporting the sliding members 8a, 8a formed on end portions of the support base 4. The support base 4 is configured to reciprocate along a longitudinal direction of the guide rail 5a by the inertia force generated by the acceleration, the deceleration and the steering of the vehicle. The guide rail 5a is provided near an end portion of the filter 1a. The dust removing body 2 is configured to move along a longitudinal direction of the support base 4 by the inertia force generated by the acceleration, the deceleration and the steering of the vehicle. Consequently, the inertia force can be converted into the force in the linear direction along the filter to use the force.

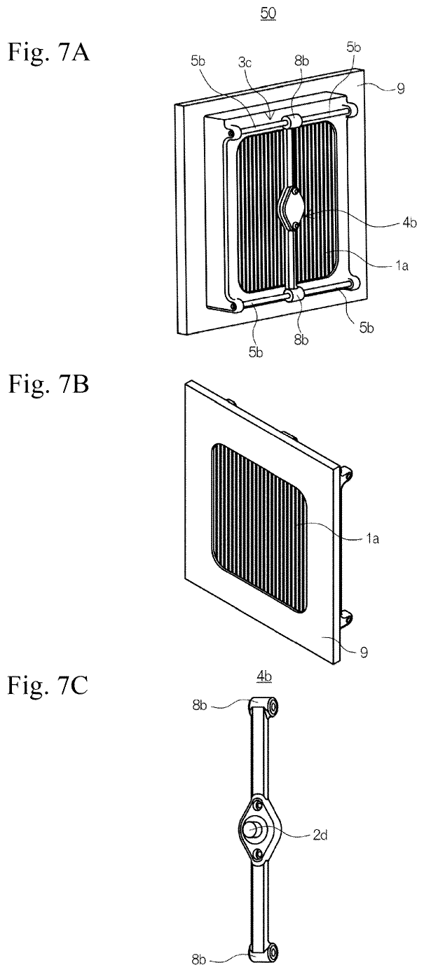

FIGS. 7A and 7B are perspective views showing the fifth embodiment of the filter cleaning device concerning the present invention. FIG. 7A illustrates the filter cleaning device from the downstream side of the filter. FIG. 7B illustrates the filter cleaning device from the upstream side of the filter. FIG. 7C is a perspective view of a support base constituting the filter cleaning device of the fifth embodiment. In a filter cleaning device 50 of the fifth embodiment, a movable mechanism 3c includes: a support base 4b having a rod shape for supporting a dust removing body 2d; and guide rails 5b, 5b configured to slidingly contact with sliding members 8b, 8b formed on end portions of the support base 4b for supporting the sliding members 8b, 8b. The support base 4b is configured to reciprocate along a longitudinal direction of the guide rail 5b by the inertia force generated by the acceleration, the deceleration and the steering of the vehicle. The guide rail 5b is provided near an end portion of the filter 1a. The dust removing body 2d is fixed on the support base 4b. Consequently, the inertia force can be converted into the force in the linear direction along the filter 1a to use the force.

In the filter cleaning device 40 of the fourth embodiment and the filter cleaning device 50 of the fifth embodiment, the sliding members and the guide rails are formed on both ends of the support base. However, it is also possible to form the sliding member and the guide rail on only one of both ends of the support base. Such a configuration is included in the present invention. It is also possible to form the sliding member and the guide rail on an approximately center portion of the support base. Such a configuration is included in the present invention.

In the filter cleaning device 40 of the fourth embodiment and the filter cleaning device 50 of the fifth embodiment, it is preferable that the guide rail includes the buffer device near an end portion of the guide rail in the longitudinal direction and the buffer device is configured to generate a repulsive force to the support base when the support base is approached to the buffer device or contacted with the buffer device for buffering a collision with the guide rail. Consequently, even when large inertia force is applied, the movable mechanism is prevented from being damaged. The explanation of the configurations of the buffer device is omitted since the configurations described in FIGS. 5A to 5C are applicable.

In the filter cleaning device 40 of the fourth embodiment and the filter cleaning device 50 of the fifth embodiment, it is preferable that the load per unit length of the support base in the longitudinal direction at the portion supported by the guide rail near the sliding member is larger than the load per unit length of the support base at the portion other than the first portion near the sliding member. Consequently, the inertia force applied on the support base can be increased and the deformation of the support base is suppressed. Thus, the support base can be slid on the guide rail smoothly.

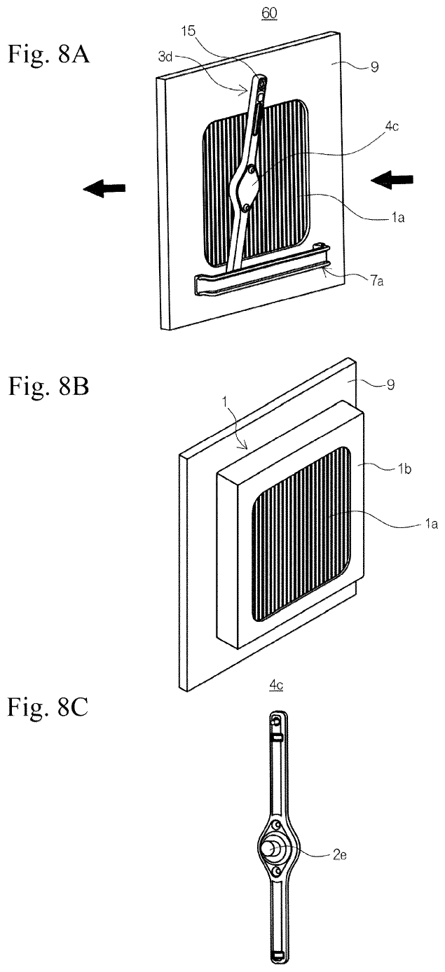

FIGS. 8A and 8B are perspective views showing the sixth embodiment of the filter cleaning device concerning the present invention. FIG. 8A illustrates the filter cleaning device from the downstream side of the filter. FIG. 8B illustrates the filter cleaning device from the upstream side of the filter. FIG. 8C is a perspective view of the support base constituting the filter cleaning device of the sixth embodiment. In a filter cleaning device 60 of the sixth embodiment, a movable mechanism 3d includes a support base 4c having a rod shape for supporting a dust removing body 2e. One end of the support base 4c is rotatably fixed to a rotation axis 15 near the filter and the other end of the support base 4c is a free end which is reciprocally movable. The dust removing body 2e is fixed to the support base 4c. Note that the reference numeral 7a functions as a dust box for collecting the dust and a stopper member for limiting the movable range of the support base 4c. In the filter cleaning device of the sixth embodiment, the dust removing body is arranged on the upstream side of the filter surface. The dust removing body exhibits the same effect and is included in the present invention when the dust removing body is arranged on the upstream side and arranged on the downstream side of the filter surface.

It is also possible to replace the support base 4c and the dust removing body 2e shown in FIG. 8C with the support base 4 having a rail shape and the dust removing body 2 having an approximately spherical shape shown in FIG. 6 so that the dust removing body 2 is moved along the longitudinal direction of the support base 4 by the inertia force generated by the acceleration, the deceleration and the steering of the vehicle. Such a configuration is included in the present invention. The dust removing body 2e is included in the present invention as long as the dust removing body 2e contacts with the filter 1a and gives a shock to the filter 1. The dust removing body 2e can be a protruded member or a rotation body having an approximately spherical shape.

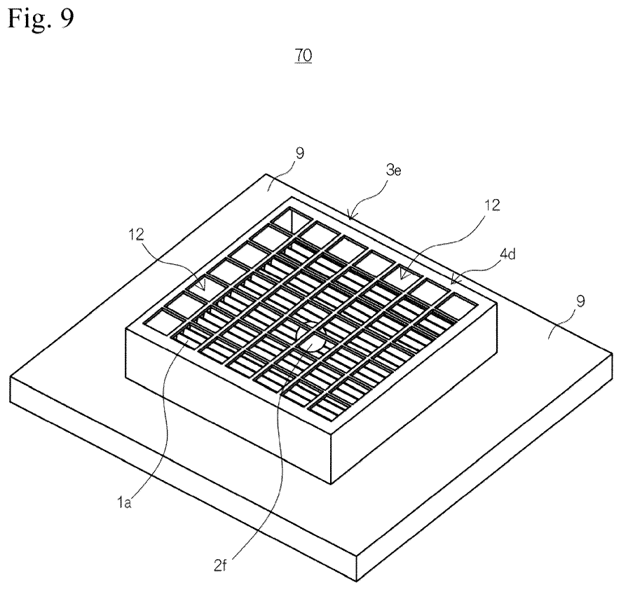

FIG. 9 is a perspective view showing the seventh embodiment of the filter cleaning device concerning the present invention. In a filter cleaning device 70 of the seventh embodiment, a movable mechanism 3e includes a support base 4d having a ventilation hole 12 and having an approximately lid shape provided at a position facing the filter 1a sandwiching a dust removing body 2f, and the dust removing body 2f is configured to freely move along the support base 4d by the inertia force generated by the acceleration, the deceleration and the steering of the vehicle. Consequently, the movable mechanism 3e can be simplified and the manufacturing cost can be reduced.

### INDUSTRIAL APPLICABILITY

The filter cleaning device of the present invention is used by being installed in a vehicle air conditioner of an automobile or the like.

### DESCRIPTION OF REFERENCE NUMERALS

1: filter body
1a: filter
1b: filter frame
1c: reinforcing member
2, 2a, 2b, 2c, 2d, 2e, 2f: dust removing body
3, 3a, 3b, 3c, 3d, 3e: movable mechanism
4, 4a, 4b, 4c, 4d: support base
5a, 5b: guide rail
6, 6a, 6b, 6c: buffer device
6g: insertion hole
6h: spring
6i: magnet
6j: cushion member
7, 7a: dust box
8a, 8b: sliding member
9: base
10, 20, 30, 40, 50, 60, 70: filter cleaning device
12: ventilation hole
13a, 13b, 13c: projected portion
14: dust
15: rotation axis
81: vehicle air conditioner body case
82: blower fan

1. A filter cleaning device provided on a vehicle air conditioner, the filter cleaning device comprising:
a filter body including a filter and a filter frame;
a dust removing body configured to strike the filter body or vibrate the filter body for removing a dust attached to the filter body; and
a movable mechanism configured to support the dust removing body and control a movement of the dust removing body, wherein
the movable mechanism is configured to relatively move the dust removing body with respect to the filter by an inertia force generated by an acceleration, a deceleration and a steering of a vehicle.

2. The filter cleaning device according to claim 1, wherein
the movable mechanism includes a support base having a rod shape or a rail shape for supporting the dust removing body,
one end or both ends of the support base is fixed near the filter, and
the dust removing body is configured to move along a longitudinal direction of the support base by the inertia force generated by the acceleration, the deceleration and the steering of the vehicle.

3. The filter cleaning device according to claim 1, wherein
the movable mechanism includes: a support base having a rod shape or a rail shape for supporting the dust removing body; and a guide rail configured to slidingly contact with a sliding member formed on an end portion or a center portion of the support base for supporting the sliding member,
the support base is configured to reciprocate along a longitudinal direction of the guide rail by the inertia force generated by the acceleration, the deceleration and the steering of the vehicle,
the guide rail is provided near an end portion of the filter, and
the dust removing body is fixed to the support base or configured to move along a longitudinal direction of the support base by the inertia force generated by the acceleration, the deceleration and the steering of the vehicle.

4. The filter cleaning device according to claim 3, wherein
the guide rail includes a buffer device near an end portion of the guide rail in the longitudinal direction, and
the buffer device is configured to generate a repulsive force to the support base when the support base is approached to the buffer device or contacted with the buffer device for buffering a collision with the guide rail.

5. The filter cleaning device according to claim 3, wherein
a first load per unit length of the support base in the longitudinal direction at a first portion supported by the guide rail near the sliding member is larger than a second load per unit length of the support base at a second portion other than the first portion near the sliding member.

6. The filter cleaning device according to claim 1, wherein
the movable mechanism includes a support base having a rod shape or a rail shape for supporting the dust removing body,
one end of the support base is rotatably fixed to a rotation axis near the filter and the other end of the support base is a free end which is reciprocally movable, and
the dust removing body is fixed to the support base or configured to move along a longitudinal direction of the support base by the inertia force generated by the acceleration, the deceleration and the steering of the vehicle.

7. The filter cleaning device according to claim 1, wherein
the movable mechanism includes a support base having an approximately lid shape provided at a position facing the filter sandwiching the dust removing body, and
the dust removing body is configured to freely move along the support base by the inertia force generated by the acceleration, the deceleration and the steering of the vehicle.

8. The filter cleaning device according to claim 2, wherein
the support base includes a buffer device near an end portion of the support base in the longitudinal direction, and
the buffer device is configured to generate a repulsive force to the dust removing body when the dust removing body is approached to the buffer device or contacted with the buffer device for buffering a collision with the support base.

9. The filter cleaning device according to claim 1, wherein
the filter includes a plurality of pleats, and
the dust removing body is configured to strike the plurality of pleats or vibrate the plurality of pleats for removing the dust attached to the filter.

10. The filter cleaning device according to claim 9, wherein
the dust removing body has an approximately spherical shape, and
the dust removing body is configured to rotate on a surface of the filter to strike the plurality of pleats by the inertia force generated by the acceleration, the deceleration and the steering of the vehicle.

11. The filter cleaning device according to claim 9, wherein
the filter includes a reinforcing member in a part of the plurality of pleats for maintaining a shape of the filter, and
the dust removing body is configured to strike the reinforcing member for vibrating the filter.

12. The filter cleaning device according to claim 1, wherein
the longitudinal direction of the guide rail or the support base in the movable mechanism is inclined with respect to a horizontal direction.

13. The filter cleaning device according to claim 1, wherein
a dust box is formed at a portion near the filter and at least at one of end portions in a direction orthogonal to a moving direction of the dust removing body.

14. The filter cleaning device according to claim 1, wherein
a movable range of the dust removing body moved by the movable mechanism includes a position where the dust removing body and the filter body are not contacted with each other.
